(19) United States
(12) Patent Application Publication
(10) Pub. No.: US 2006/0144500 A1
(43) Pub. Date: Jul. 6, 2006

(54) Method and an apparatus for assembling tyres for vehicle wheels

(76) Inventor: Claudio Lacagnina, Busto Arsizio (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/530,364

(22) PCT Filed: Nov. 5, 2002
(86) PCT No.: PCT/IT02/00699

§ 371 Date: Nov. 14, 2005

(51) Int. Cl. B29D 30/08; B29D 30/60

(52) U.S. Cl. 156/111; 156/117; 156/130; 156/126; 156/396; 156/397; 156/406.2

(57) ABSTRACT

A method of assembling tyres for vehicle wheels includes disposing a carcass structure on a primary drum, disposing a belt structure on an auxiliary drum, picking up the belt structure from the auxiliary drum to transfer the belt structure to a position coaxially centered with respect to the carcass structure, and applying a tread band onto the belt structure. The carcass structure includes at least one carcass ply in engagement with annular anchoring structures axially spaced apart from each other. The belt structure includes at least one belt layer. Applying the tread band is carried out by winding up at least one continuous strip element of elastomer material in contiguous circumferential coils around the belt structure. An apparatus for assembling tyres for vehicle wheels includes the primary drum, the auxiliary drum, at least one unit for applying a tread band onto a belt structure, and a transfer member.

The present invention relates to a method of assembling tyres for vehicle wheels. The invention also pertains to an apparatus for assembling vehicle tyres, to be used for putting into practice the above mentioned assembling method.

A tyre for vehicle wheels generally comprises a carcass structure including at least one carcass ply having respectively opposite end flaps turned up loop-wise around annular anchoring structures, each of said anchoring structures being usually made up of a substantially circumferential annular insert onto which at least one filling insert is applied, at a radially external position thereof.

Associated with the carcass structure is a belt structure comprising one or more belt layers, arranged in radial superposed relationship with each other and with the carcass ply and having textile or metallic reinforcing cords of crossed orientation and/or disposed substantially parallel to the circumferential extension direction of the tyre. Applied to the belt structure at a radially external position thereof is a tread band, made of elastomer material like other semifinished products being constituent parts of the tyre.

To the aims of the present description it is: to be pointed out that by the term “elastomer material” it is meant a rubber blend in its entirety, i.e. the compound made up of at least one base polymer suitably amalgamated with reinforcing fillers and/or process additives of various types.

In addition respective sidewalls of elastomer material are also applied to the side surfaces of the carcass structure, each of them extending from one of the side edges of the tread band until close to the respective annular anchoring structure at the beads, which sidewalls, depending on the different embodiments, can exhibit respective radially external end edges either superposed on the side edges of the tread band so as to form a design scheme of the type usually referred to as “overlying sidewalls”, or interposed between the carcass structure and the side edges of the tread band itself, in accordance with a design scheme of the type referred to as “underlying sidewalls”.

In most of the known processes for tyre manufacture, the carcass structure and belt structure together with the respective tread band are provided to be made separately of each other in respective work stations, to be mutually assembled at a later time.

More particularly, manufacture of the carcass structure first contemplates deposition of the carcass ply or plies on a first drum usually identified as “building drum” to form a cylindrical sleeve. The annular anchoring structures at the beads are fitted or formed on the opposite end flaps of the carcass ply or plies that in turn are turned up around the annular structures themselves so as to enclose them in a sort of loop.

Simultaneously, on a second drum or auxiliary drum, an outer sleeve is made which comprises the belt layers laid down in radially superposed relationship with each other, and the tread band applied to the belt layers at a radially external position thereof. The outer sleeve is then picked up from the auxiliary drum to be coupled with the carcass sleeve. For the purpose, the outer sleeve is disposed in coaxial relation around the carcass sleeve, afterwards the carcass ply or plies are shaped into a toroidal conformation by axially moving the beads close to each other and simultaneously admitting fluid under pressure into the carcass sleeve, so as to determine application of the belt band and the tread band to the carcass structure of the tyre at a radially external position thereof. Assembling of the carcass sleeve with the outer sleeve can be carried out on the same drum as used for building the carcass sleeve, in which case reference is made to a “unistage building process”. A building process of this type is described in document U.S. Pat. No. 3,990,931, for example.

Alternatively, assembling may be carried out on a so called “shaping drum” onto which the carcass sleeve and outer sleeve are transferred, to build the tyre following a so-called “two-stage building process”, as described in document EP 0 613 757, for example.

In conventional assembling methods the tread band is usually obtained from a continuously-extruded section member that, after being cooled for stabilisation of its geometrical conformation, is stored on suitable benches or reels. The semifinished product in the form of sections or of a continuous strip is then sent to a feeding unit carrying out either picking up of the sections or cutting of the continuous strip into sections of given length, each of them constituting the tread band to be circumferentially applied to the belt structure of a tyre being processed.

Known from document GB 1, 04 8, 241 is a machine for laying down a layer of elastomer material of varying thickness on a tyre carcass and comprising a feeding head to apply a ribbon of elastomer material to the carcass, means for setting the carcass in rotation around its axis for winding of a plurality of coils thereon when the carcass rotates with respect to the feeding head, means for moving the feeding head transversely of the carcass, from one side to the other of the circumferential median plane of the carcass, and means for automatically varying the transverse-movement amount for each winding revolution so as to vary the overlapping degree of the contiguous coils and consequently thickness of the layer formed on the carcass. In an appropriate version for making new tyres, during formation of the tread band the carcass is mounted on a building drum and has a cylindrical right conformation.

In document WO 01/36185, in the name of the same Applicant, a robotized arm bears a toroidal support on which each of the components of a tyre under production is directly made. The robotized arm gives the toroidal support a circumferential-distribution motion around its geometric axis, simultaneously with controlled transverse-distribution displacements in front of a delivery member supplying a narrow strip of elastomer material. The narrow strip therefore forms a plurality of coils the orientation and mutual-overlapping parameters of which are suitably managed so as to control the variations in thickness to be given to a component of a tyre being made, based on a predetermined deposition scheme preset on an electronic computer.

In the production contexts to which the present invention (contemplating production and storage of semifinished products and subsequent assembling of same on a building and/or shaping drum) is addressed, for manufacturing the tread bands, installation of extrusion lines is presently required that must necessarily have a high productivity, in order to offer appropriate responses in terms of economy on a large scale. As a result, an extrusion line is usually capable of supplying a plurality of assembling stations. In fact, productivity of the extrusion line is required to be adjusted in proportion to the productivity of the assembling stations the number of which has an influence on saturation and therefore productivity of the extrusion line.

In accordance with the present invention, the Applicant intends to overcome the strong constraints imposed by the above described circumstance, that particularly reveal themselves in the impossibility of the production plants being modified in response to sudden variations in the market demand in terms of productivity and product typology. In fact, since the plant productivity is greatly connected with the productivity of the tread band extrusion line, an increase in productivity would normally require installation of a further extrusion line, which would bring about an increase in the production capacity that at this point. would be in excess with respect to the real market demand.

In dealing with the above discussed problems, the

Applicant realized the possibility of achieving great improvements in terms of production flexibility and quality of the product by manufacturing the tread band in the present tyre building processes contemplating assembling of semifinished products, through winding up of a continuous strip-like element into coils disposed in side by side relationship directly on the belt structure.

In more detail, it is an object of the present invention to provide a method of assembling tyres for vehicle wheels comprising the steps of: disposing on a primary drum, a carcass structure comprising at least one carcass ply in engagement with annular anchoring structures at the beads axially spaced apart from each other; disposing a belt structure comprising at least one belt layer, on an auxiliary drum; applying a tread band onto the belt structure; picking up the belt structure from the auxiliary drum to transfer it to a position coaxially centred with respect to the carcass structure; wherein application of the tread band contemplates the step of winding up at least one continuous strip-like element of elastomer material in contiguous circumferential coils around the belt structure.

In accordance with a further inventive aspect, the above mentioned method can be carried out by means of an apparatus for assembling tyres for vehicle wheels comprising: a primary drum arranged to support a carcass structure comprising at least one carcass ply in engagement with anchoring structures at the beads axially spaced apart from each other; an auxiliary drum set to carry a belt structure; at least one unit for application of a tread band to the belt structure; a transfer member to move the belt structure from the auxiliary drum to the carcass structure; wherein said application unit comprises at least one delivery member to lay down at least one continuous strip-like element of elastomer material in contiguous circumferential coils on the belt structure.

Further features and advantages will become more apparent from the detailed description of a preferred, but not exclusive, embodiment of a method and an apparatus for assembling tyres for vehicle wheels, in accordance with the present invention.

This description will be set out hereinafter with reference to the accompanying drawings, given by way of non-limiting example, in which:

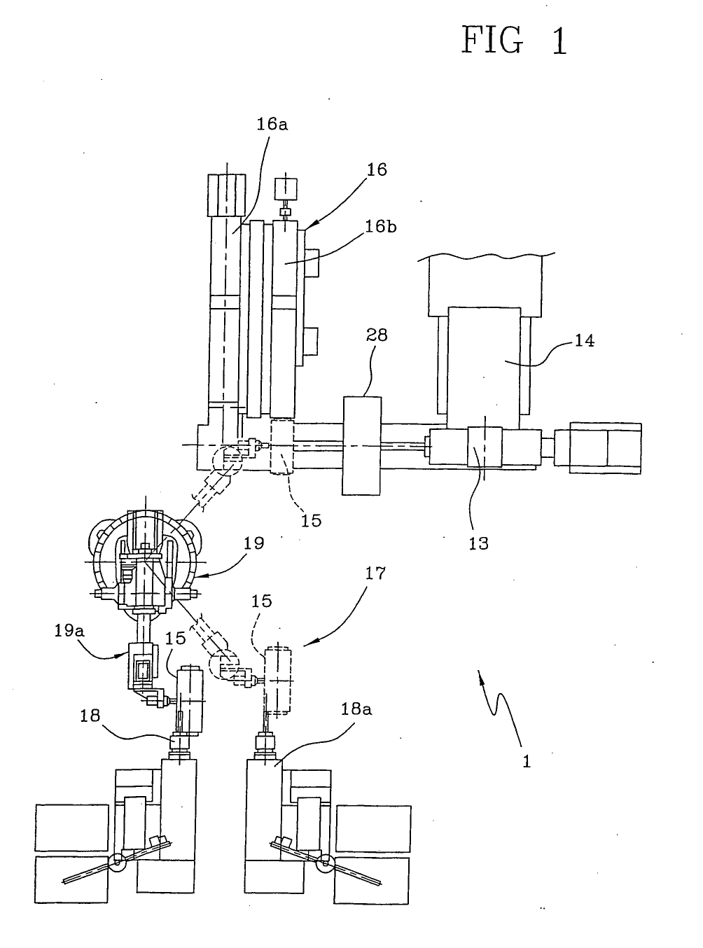

FIG. 1 is a diagrammatic top view of an apparatus for assembling tyres in accordance with the present invention;

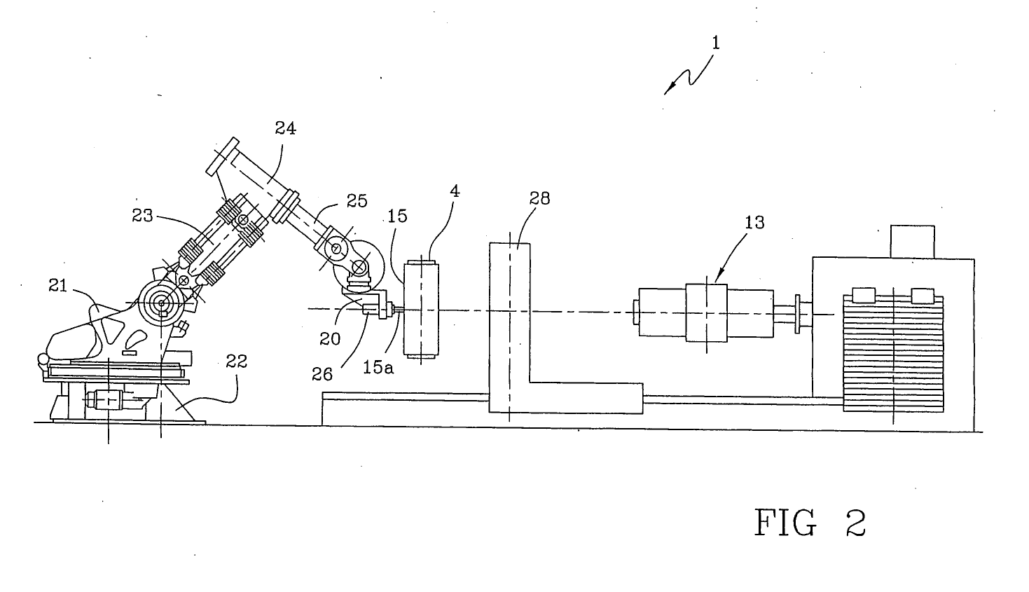

FIG. 2 is an elevation view of the apparatus in FIG. 1;

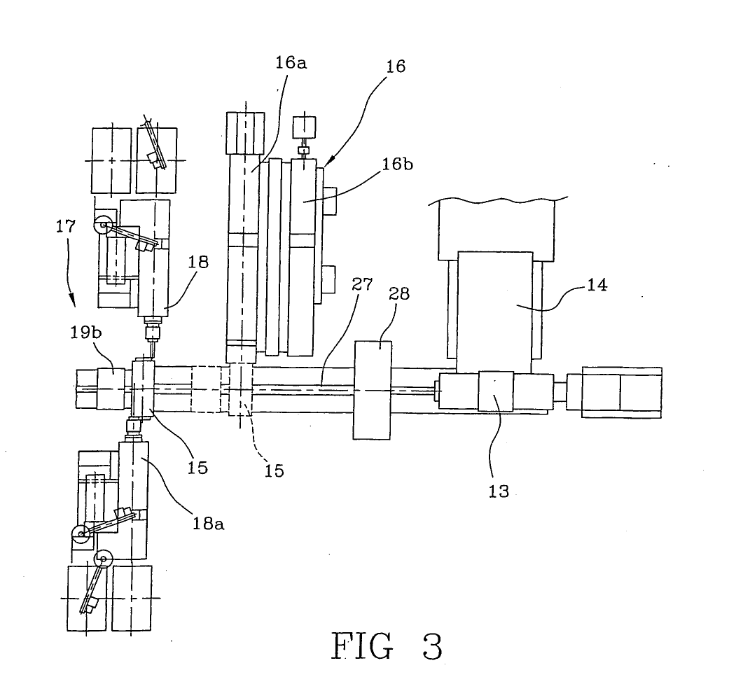

FIG. 3 is a diagrammatic top view of an apparatus for assembling tyres in accordance with a possible alternative embodiment of the present invention;

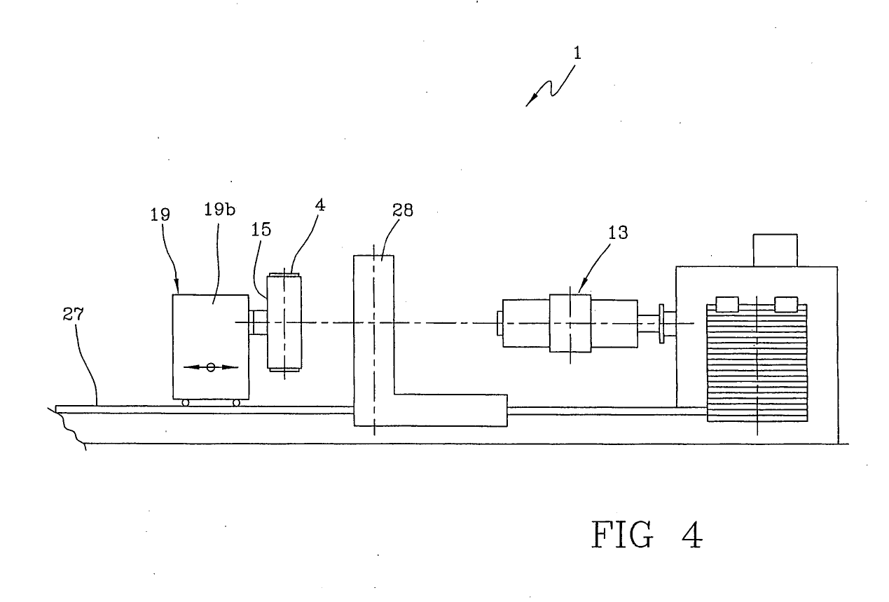

FIG. 4 is an elevation view of the apparatus in FIG. 3;

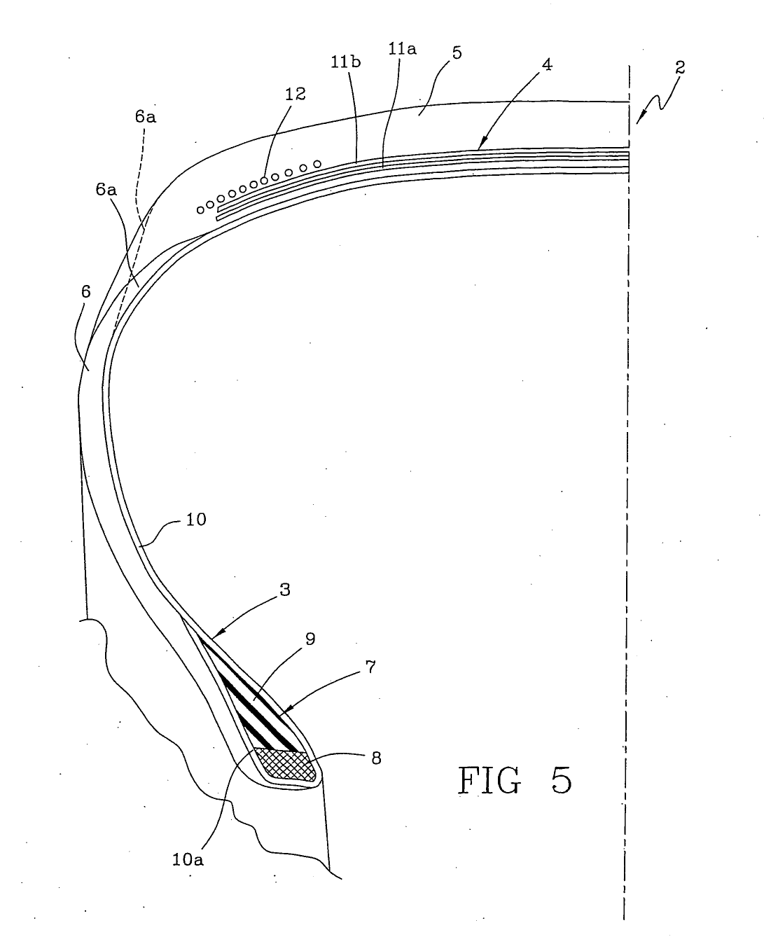

FIG. 5 is a diagrammatic fragmentary cross-section view of a tyre obtainable in accordance with the present invention.

Referring particularly to FIGS. 1 to 3, an apparatus for assembling tyres for vehicle wheels set to put into practice an assembling method in accordance with the present invention has been generally identified by reference numeral 1.

The invention aims at making tyres of the type generally identified with 2 in FIG. 5, essentially comprising a carcass structure 3 of substantially toroidal conformation, a belt structure 4 of substantially cylindrical conformation, circumferentially extending around the carcass structure 3, a tread band 5 applied to the belt structure 4 at a circumferentially external position thereof, and a pair of sidewalls 6 laterally applied, on opposite sides, to the carcass structure 3 and each extending from a side edge of the tread band until close to a radially internal edge of the carcass structure itself.

Each sidewall 6 may exhibit a radially external end tailpiece 6a at least partly covered with the extremity of the tread band 5, as shown in solid line in FIG. 5, following a design scheme of the type usually identified as “underlying sidewalls”. Alternatively, the radially external end tailpieces 6a of sidewalls 6 can be laterally superposed on the corresponding extremities of the tread band 5, as shown in chain line in FIG. 5, to achieve a design scheme of the type usually identified as “overlying sidewalls”.

The carcass structure 3 comprises a pair of annular anchoring structures 7 integrated into regions usually identified as “beads”, each of them being for example made up of a substantially circumferential annular insert 8 usually called “bead core” and carrying an elastomer filler 9 at a radially external position thereof.

Turned up around each of the annular anchoring structures are the end flaps 10a of one or more carcass plies 10 comprising textile or metallic cords extending transversely of the circumferential extension of tyre 2, possibly following a predetermined inclination between the two annular anchoring structures 7.

The belt structure 4 can in turn comprise one or more belt layers 11a, 11b including metallic or textile cords suitably inclined to the circumferential extension of the tyre, in respectively crossed orientations between one belt layer and the other, as well as a possible external belting layer 12 including one or more cords circumferentially wound into coils axially disposed in side by side relationship around the belt layers 11a, 11b.

In heavy-duty tyres, tyres for trucks and heavy transport vehicles for example, the belt structure may also incorporate a gravel-guard strip (not shown) adapted to prevent foreign bodies from entering the underlying belt layers.

The sidewalls 6 and tread band 5 each essentially comprise at least one layer of elastomer material of suitable thickness. Also associated with the thread band 5 may be a so-called substrate (not shown), of elastomer material having appropriate composition and physico-chemical features and acting as an interface between the true tread band and the underlying belt structure 4.

The individual components of the carcass structure 3 and belt structure 4, such as in particular the annular anchoring structures 7, carcass plies 10, belt layers 11a, 11b and further possible reinforcing elements designed to constitute the outer belting layer 12, are supplied to apparatus 1 in the form of semifinished products made during preceding manufacturing steps, to be suitably assembled with each other.

Apparatus 1 comprises a primary drum 13, not shown in detail as it can be made in any convenient manner, on which the carcass ply or plies 10 are first wound up; said plies come from a feeding line 14 along which they are cut into sections of appropriate length correlated with the circumferential extension of the primary drum 13, before being applied thereto to form a so-called substantially cylindrical “carcass sleeve”. Afterwards, the annular anchoring structures 7 are fitted onto the end flaps 10a of plies 10 to subsequently carry out turning-up of the end flaps themselves to cause engagement of the anchoring structures into the loops thus formed by the turned-up plies 10. Applied to the carcass sleeve can also be the tyre sidewalls 6 coming from at least one respective sidewall-feeding line (not shown) supplying a semifinished product in the form of a continuous strip of elastomer material from which sections of a predetermined length are cut out, said length being correlated with the circumferential extension of the primary drum 13 and the tyre 2 to be obtained.

Alternatively, assembling of the carcass structure 3 components and possibly of the sidewalls 6 too, can be carried out separately on a different building drum, so that the assembled carcass sleeve will be subsequently transferred onto the primary drum 13.

Simultaneously with assembling of the carcass structure 3 components, in the form of a cylindrical sleeve, on the primary drum 13, or with transfer thereto of the already assembled carcass structure, the belt structure 4, and preferably the tread band 5 as well, are disposed on an auxiliary drum 15.

More particularly, to this aim the auxiliary drum 15 is provided to be such arranged, in coaxial-alignment relationship with the primary drum 15 for example, that it interacts with devices 16 for application of the belt structure 4 on the auxiliary drum itself. By way of example, said devices 16 for application of the belt structure may comprise at least one feeding line 16a along which the semifinished products in the form of a continuous strip are caused to move forward, said strip being then cut into sections of a length corresponding to the circumferential extension of the auxiliary drum 15, concurrently with formation of the corresponding belt layers 11a, 11b thereon. A feeding unit for supplying a gravel-guard strip 16b as well as a feeding unit for supplying one or more continuous cords (not shown in the drawings) to be applied onto the belt layers to form axially contiguous circumferential coils, may be combined with the feeding line of the belt layers 16a.

When formation of the belt structure 4 has been completed, movement of the auxiliary drum 15 is carried out starting from a position at which it interacts with the devices for application of the belt structure 16, to be submitted to the action of at least one unit for application of the tread band, generally denoted by 17.

The tread band application unit 17 comprises at least one delivery member 18 set to lay down at least one continuous strip-like element of elastomer material in contiguous circumferential coils on the belt structure 4 in more detail, the delivery member 18 may for example comprise an extruder, an applicator roller or another member adapted to delivery the continuous strip-like element of elastomer material directly against the belt structure 4 supported by the auxiliary drum 15, simultaneously with winding up of the strip-like element itself around the belt structure 4. An actuating assembly 19 operates on the auxiliary drum 15 to drive it in rotation around a geometric axis thereof, so that the strip-like element is circumferentially distributed on the belt structure 4. Simultaneously, the actuating assembly 19 carries out controlled relative displacements between the auxiliary drum 15 and delivery member 18, to distribute the strip-like element in coils disposed in mutual side by side relationship to form the tread band 5 in accordance with the desired thickness and geometric-conformation requirements.

In a preferential embodiment shown in FIGS. 1 and 2, the actuating assembly 19 is integrated into at least one robotized arm 19a carrying an end head 20 to which the auxiliary drum 15 is fastened in cantilevered fashion by a shank 15a coincident with the geometric axis thereof. In the example shown (see FIG. 2) the robotized arm 19a comprises a base 21 rotating on a fixed platform 22 around a first vertical axis, a first portion 23 oscillatably connected to base 21 around a second, preferably horizontal, axis, a second portion 24 oscillatably connected to the first portion 23 around a third axis, which is preferably horizontal too, and a third portion 25 rotatably supported by the second portion 24 around an axis orthogonal to the third oscillation axis. The head 20 of the robotized arm 19a is connected at its end with the third portion, being allowed to oscillate around a fifth and a sixth oscillation. axes that are perpendicular to each other, and rotatably carries the auxiliary drum 15, operable in rotation by a motor 26.

The robotized arm 19a, therefore is adapted to support the auxiliary drum 15 and to control movement of same during the whole production cycle, driving it in rotation in front of the feeding lines of the belt layers 16a, 16b for the purpose of their application, and subsequently taking it in front of the extruder 18 of the continuous strip-like element designed to constitute the tread band 5. When for the tread band 5 manufacture formation of a substrate is required, an auxiliary extruder 18a may be provided for feeding the elastomer material, still in the form of a continuous strip-like element, designed to constitute such a substrate. In this case, the auxiliary drum 15 is first moved towards the auxiliary extruder 18a intended for making the substrate, and subsequently transferred to extruder 18 for manufacture of the true tread band 5.

During manufacture of the tread band 5, each of the extruders 18, 18a keeps a fixed positioning, while the auxiliary drum 15 is driven in rotation and suitably moved in a transverse direction by the robotized arm 19a, so as to cause distribution of the continuous strip-like element in order to form a layer of appropriate shape and thickness upon the belt structure 4. The continuous strip-like element fed from each of the extruders 18, 18a can advantageously have a flattened section so that it can modulate the thickness of the elastomer layer formed on the belt structure 4 by varying the overlapping amount of the contiguous coils and/or orientation of the surface of the belt structure 4 with respect to the cross-section outline of the strip-like element coming from the extruder 18, 18a.

Once manufacture of the tread band 5 has been completed, the robotized arm 19a causes a new translation of the auxiliary drum 15 to move it away from the extruder 18 or other delivery member and to position it again in axial-alignment relationship with respect to the primary drum 13.

In a possible alternative embodiment shown in FIGS. 3 and 4, the actuating assembly 19 comprises a carriage 19b movable along a guide structure 27, between a first position at which, as shown in chain line in FIG. 3, it supports the auxiliary drum 15 in front of the devices for application of the belt structure 16, and a second position at which, as shown in solid line in FIG. 3, it supports the auxiliary drum 15 in front of the extruder or extruders 18, 18a being part of the application unit 17.

The belt structure 4. carrying the tread band 5 is adapted to be picked up by the auxiliary drum 15 and transferred onto the carcass structure in the form of a cylindrical sleeve that has been meanwhile formed or engaged on the primary drum 13. To this aim a transfer member 28 of substantially annular conformation is moved until it is positioned around the auxiliary drum 15 to pick up the belt structure 4 and tread band 5 therefrom. In a manner known by itself, the auxiliary drum 15 disengages the belt structure 4 that is then axially translated by the transfer member 28 to be placed to a coaxially centred position on the primary drum 13 carrying the carcass sleeve.

The carcass sleeve is then shaped into a toroidal configuration by axially moving the annular anchoring structures 7 close to each other and simultaneously admitting fluid under pressure into the sleeve itself until the carcass plies are brought into contact with the inner surface of the belt structure 4 held by the transfer member 28. The tyre 2 thus built lends itself to be removed from the primary drum 1.3 to be afterwards submitted to a normal vulcanisation step.

Unlike the above described embodiments, the tread band 5 can be suitably made subsequently to transfer of the belt structure 4 onto the carcass sleeve 3. In this case, the actuating assembly 19 will be set to operate on the primary drum 13 in front of the delivery member or members 18, 18a for the purpose of forming the tread band 5, by carrying out a relative movement between said actuating assembly 19, primary drum 13 and/or delivery member or members 18, 18a. In this case, when formation of the tread band 5 is carried out, the belt structure 4 will be already in engagement with the carcass sleeve 3, shaped in a toroidal configuration.

In accordance with another alternative embodiment, that can be adopted in anyone of the above described embodiments, the actuating assembly 19 may be provided to carry out translation of the delivery member or members 18, 18a transversely of the circumferential extension of the belt structure 4, to cause a transverse distribution of the coils formed of the continuous strip-like element.

The present invention achieves important advantages.

Manufacture of the tread band 5 by winding a continuous strip-like element into coils disposed in side by side relationship enables in fact all the limits of the known art correlated with the requirement of using complicated and bulky machinery for tread band production through extrusion, to be overcome; in fact use of this complicated and bulky machinery involves high investment and running costs only justified by a production on a large scale. The invention on the contrary enables the tread band to be produced with much simpler and less bulky machinery, suitable for a production adjusted in proportion to the productivity of the individual assembling apparatus 1.

Consequently, tyre-building plants currently in use and comprising a plurality of assembling apparatus interlocked with the same tread band extrusion line can be advantageously adapted to the increases in productivity requested by the market, by merely adding one or more apparatus according to the invention, so as to obtain an increase in productivity meeting the market requirements.

It should be also appreciated that the present invention enables a greater evenness of the tread band to be achieved, which evenness in the known art was greatly conditioned by a correct distribution of the strip of raw elastomer material being applied around the belt structure, particularly at the end-to-end junction of the extremities of the strip itself.

In the known art, these conditions also gave rise to a great number of discarded products, the present invention, on the contrary, allowing to eliminate them.

In addition, further advantages from a qualitative point of view have repercussions on traditional extrusion lines when the apparatus in reference is used in combination with other apparatus interlocked with an extrusion line of known type. For example, combination of the concerned apparatus with a known plant provided with one or more traditional extrusion lines makes it possible to reduce productivity of the extrusion lines when it is necessary to carry out working of particular blends and materials that, due to process requirements, cannot be extruded at high speed, without on the other hand impairing the overall productivity of the plant. In addition, the extrusion lines can be advantageously utilised with an appropriate margin from their maximum productivity limit, under such conditions that more guarantees in terms of constancy in the quality of the obtained product are obtained.

1-18. (canceled)

19. A method of assembling tyres for vehicle wheels, comprising:
disposing a carcass structure on a primary drum;
disposing a belt structure on an auxiliary drum;
picking up the belt structure from the auxiliary drum to transfer the belt structure to a position coaxially centered with respect to the carcass structure; and
applying a tread band onto the belt structure;
wherein the carcass structure comprises at least one carcass ply in engagement with annular anchoring structures axially spaced apart from each other,
wherein the belt structure comprises at least one belt layer, and
wherein applying the tread band is carried out by winding up at least one continuous strip element of elastomer material in contiguous circumferential coils around the belt structure.

20. The method of claim 19, wherein applying the tread band is carried out before picking up the belt structure from the auxiliary drum.

21. The method of claim 19, wherein the at least one strip element is fed from at least one delivery member disposed close to the belt structure, simultaneously with winding up the at least one strip element around the belt structure.

22. The method of claim 21, wherein feeding the at least one strip element is carried out by extrusion through the at least one delivery member.

23. The method of claim 21, further comprising:
giving the auxiliary drum carrying the belt structure a circumferential-distribution rotary motion around a geometric rotation axis of the auxiliary drum, so that the at least one strip element is circumferentially distributed around the belt structure; and
carrying out controlled relative transverse-distribution displacements between the auxiliary drum and the at least one delivery member, so that the at least one strip element forms a plurality of coils disposed in mutual side-by-side relationship to define the tread band;
wherein giving the auxiliary drum the circumferential-distribution rotary motion and carrying out the controlled relative transverse-distribution displacements are carried out concurrently with winding up the at least one strip element.

24. The method of claim 23, wherein the controlled relative transverse-distribution displacements are carried out by movement of the auxiliary drum.

25. The method of claim 23, wherein the circumferential-distribution rotary motion and the controlled relative transverse-distribution displacements are carried out by an actuating assembly engaging the auxiliary drum.

26. The method of claim 21, wherein before transferring the belt structure to a position coaxially centered with respect to the carcass structure, the auxiliary drum is moved away from the at least one delivery member to a position in which the auxiliary drum interacts with devices for disposing the belt structure.

27. The method of claim 26, wherein after formation of the belt structure and before winding up the at least one strip element, the auxiliary drum is moved from the position in which the auxiliary drum interacts with devices for disposing the belt structure towards the at least one delivery member.

28. The method of claim 19, wherein disposing the carcass structure on the primary drum is carried out by assembling component parts of the carcass structure on the primary drum.

29. The method of claim 19, wherein the belt structure transferred to the position coaxially centered with respect to the carcass structure is coupled with the carcass structure following shaping the carcass structure into a toroidal configuration.

30. An apparatus for assembling tyres for vehicle wheels, comprising:
a primary drum;
an auxiliary drum;
at least one unit for applying a tread band onto a belt structure; and
a transfer member;
wherein the primary drum is arranged to support a carcass structure,
wherein the carcass structure comprises at least one carcass ply in engagement with annular anchoring structures axially spaced apart from each other,
wherein the auxiliary drum is set to carry the belt structure,
wherein the transfer member moves the belt structure from the auxiliary drum to the primary drum,
wherein the at least one unit for applying the tread band comprises at least one delivery member, and
wherein the at least one delivery member lays down at least one continuous strip element of elastomer material in contiguous circumferential coils onto the belt structure.

31. The apparatus of claim 30, wherein the at least one delivery member comprises at least one extruder.

32. The apparatus of claim 30, wherein the at least one unit for applying the tread band comprises:
an actuating assembly;
wherein the actuating assembly drives the auxiliary drum in rotation around a geometric axis of the auxiliary drum so that the at least one strip element is circumferentially distributed onto the belt structure, and
wherein the actuating assembly causes controlled relative transverse-distribution displacements between the auxiliary drum and the at least one delivery member for distributing the at least one strip element to form the circumferential coils disposed in mutual side-by-side relationship that define the tread band.

33. The apparatus of claim 32, wherein the actuating assembly operates on the auxiliary drum to move the auxiliary drum relative to the at least one delivery member.

34. The apparatus of claim 32, wherein the actuating assembly is integrated into a robotized arm engaging the auxiliary drum.

35. The apparatus of claim 32, wherein the actuating assembly comprises:
a carriage movable along a guide structure between a first position and a second position;
wherein in the first position, the carriage supports the auxiliary drum near devices for disposing the belt structure, and
wherein in the second position, the carriage supports the auxiliary drum near the at least one delivery member.

36. The apparatus of claim 32, further comprising:
devices for applying belt layers on the auxiliary drum to form the belt structure;
wherein the actuating assembly is arranged to cause translation of the auxiliary drum towards the at least one delivery member, starting from a position in which the auxiliary drum interacts with devices for disposing the belt structure.
